(19) United States
(12) Patent Application Publication
(10) Pub. No.: US 2007/0263832 A1
(43) Pub. Date: Nov. 15, 2007

(54) Time-division multiplexing exchange system

(75) Inventor: Jun-Hong Chen, Hsin-Chu City (TW)

Correspondence Address: JUN-HONG CHEN, 20525 Via Talavera, Yorba Linda, CA, 92887, US

(73) Assignee: TECOM CO., LTD.

(21) Appl. No.: 11/408,691

(22) Filed: Apr. 24, 2006

(51) Int. Cl. H04M 7/00

(52) U.S. Cl. 379/219

(57) ABSTRACT

A time-division multiplexing (TDM) exchange system enables the use of one pair of communication wires by a plurality of communication terminal devices at the same time to thereby reduce hardware and labor costs, and increase the economic effect of the exchange. The TDM exchange system includes a microprocessor, a customized integrated circuit (IC), and a plurality of branch interfaces.

### FIELD OF THE INVENTION

The present invention relates to a time-division multiplexing (TDM) exchange system, and more particularly to an exchange system that enables the use of one pair of communication wires by a plurality of communication terminal devices at the same time through a time-division multiplex communication technique, so that the connection of the communication terminal devices to the exchange is simplified, and a decreasing of quantity used in communication wire can be achieved.

### BACKGROUND OF THE INVENTION

In the modern society, various kinds of communication terminal devices are used by business offices, homes, and individuals. Among others, telephone has particularly become an important and requisite tool for the communication in daily life. The quantities of telephone sets being used as well as the communication equipment and wiring for providing communication via telephone are surprisingly high.

To save the cost of communication, most places at where a large quantity of phones are needed, such as business offices, organizations, and governmental institutes, would normally install an exchange, to which multiple communication terminal devices, such as extensions, are connected for use by a large number of persons. In a conventional exchange, each extension is connected to a branch interface of the exchange via a pair of telephone wires. When the number of extensions is large, a large quantity of telephone wire is needed. Moreover, the conventional exchange must provide a branch interface for each of the extensions, resulting in high cost for the exchange equipment. In addition, a large manpower is needed to do and maintain the wiring between the exchange and the extensions.

It is therefore tried by the inventor to develop a time-division multiplexing (TDM) exchange system to enable the use of one pair of communication wires by a plurality of communication terminal devices at the same time to reduce hardware and labor costs and increase the economic effect of the exchange.

### SUMMARY OF THE INVENTION

A primary object of the present invention is to provide a TDM exchange system that enables the supply of power and communication services to a plurality of communication terminal devices via only one pair of communication wires, so as to largely reduce the quantities of communication wire and exchange system components, and accordingly, the overall equipment cost of the exchange system.

Another object of the present invention is to provide a TDM exchange system that enables each branch interface of the exchange to connect and provide services to multiple communication terminal devices at the same time to largely increase the economic effect of the exchange.

A further object of the present invention is to provide a TDM exchange system that requires reduced numbers of wires and parts to largely simplify the wiring and maintenance of the whole communication network, and allows easy connection of new communication terminal devices to the exchange without increasing the manpower needed to maintain the exchange system.

In a preferred embodiment of the present invention, the TDM exchange system includes a microprocessor for providing TDM communication services to a plurality of communication terminal devices; a customized integrated circuit (IC) for integrating the electronic circuits in the plurality of communication terminal devices into an integrated circuit; and a plurality of branch interfaces connected to the microprocessor via the customized IC. Each of the branch interfaces includes a transceiving circuit and a transformer, and is linked to at least one communication terminal device via only one pair of communication wires.

According to the present invention, a plurality of communication terminal devices may be connected to one branch interface in parallel or in series.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the framework of the time-division multiplexing (TDM) exchange system according to the present invention;

4

FIG. 2 is a block diagram showing the structure of a branch interface included in the TDM exchange system of the present invention; and

FIG. 3 is a block diagram showing the structure of an extension connected to the TDM exchange system of the present invention.

### DETAILED DESCRIPTION OF THE PREFERRED EMBODIMENTS

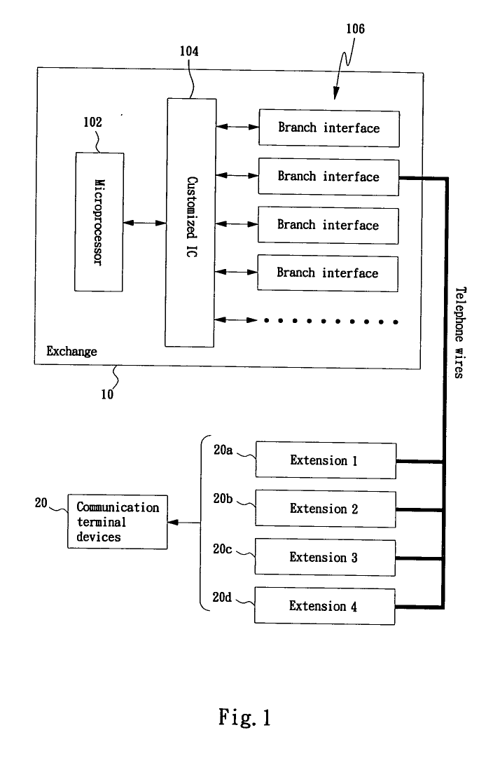

Please refer to FIG. 1 that is a block diagram showing a framework of a time-division multiplexing (TDM) exchange system according to the present invention. As shown, in the framework of the present invention, there are included an exchange 10 and a plurality of communication terminal devices 20. In the illustrated preferred embodiment, the communication terminal devices 20 are four various extensions 20a-20d. However, it is understood the communication terminal devices 20 may be any other devices for communication, and the number of the extensions is not limited to four but may be less or more.

The exchange 10 includes a first microprocessor 102, a first customized integrated circuit (IC) 104, and a plurality of branch interfaces 106.

The first microprocessor 102 functions to provide time-division multiplex communication services, and controls all functions and flows of the exchange 10 via programs.

The first customized IC 104 is located between and connected to the first microprocessor 102 and the plurality of branch interfaces 106 to integrate electronic circuits of the plurality of extensions 20 into an integrated circuit (IC).

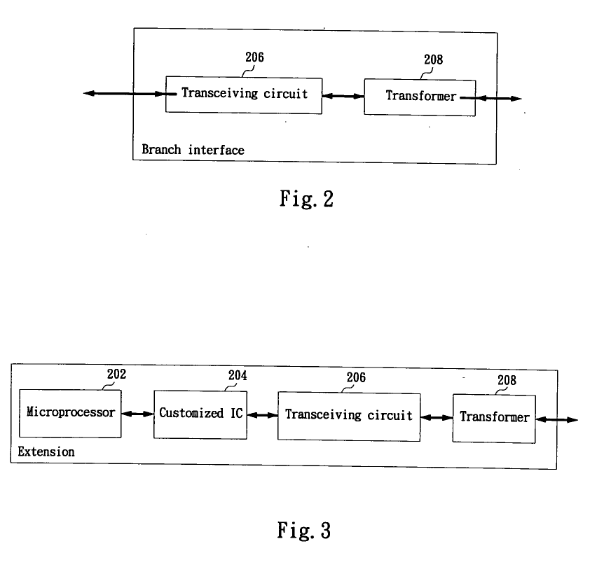

Please refer to FIG. 2. Each of the plurality of branch interfaces 106 includes a first transceiving circuit 206 and a first transformer 208, and every branch interface 106 is connected via a pair of telephone wires to at least one extension 20 for communicating with the extension 20. At least one extension 20 may be, for example, a first, a second, a third, and a fourth extension, 20a, 20b, 20c, and 20d. Wherein, the first transceiving circuit consists of a transistor adapted to conduct analog and digital signal conversion. The first transformer 208 is used to couple signals and isolate direct current (DC) voltage.

Each of the branch interfaces 106 may be connected to a different number of extensions 20 for communication. The extensions 20 may be connected to the branch interface 106 either in parallel or in series.

For example, one of the branch interfaces 106 is to connect to four extensions 20a, 20b, 20c, 20d, and a distance between the four extensions 20a-20d and the exchange 10 is 200 meters. In this case, it needs to extend only one pair of telephone wires from the branch interface 106 to an area near the four extensions 20a-d. The four extensions 20a-d are then parallelly connected to the pair of telephone wires. That is, the length of the telephone wire required for connecting the exchange 10 to the four extensions 20a-20d is about 200 meters, and only one branch interface 106 is occupied. However, when the four extensions 20a-20d are connected to other conventional exchanges, total four branch interfaces 106 are needed to connect to one extension 20 each via one pair of telephone wires. That is, total 800 meters of telephone wire and total four branch interfaces 106 are required to connect the four extensions 20a-20d to the exchange. Therefore, with the time-division multiplexing exchange system of the present invention, total 600 meters of telephone line and three branch interfaces are saved, compared to the conventional exchange system.

In another preferred example (not shown in the drawings), one of the branch interfaces 106 is to connect to 3 extensions 20a-20c. Wherein, a distance between a first extension A and an exchange 10 is 100 meters, a second extension B is 100 meters apart from the first extension A and 200 meters from the exchange 10, and a third extension C is 100 meters away from the second extension B and 300 meters from the exchange 10. In this case, it needs to extend only one pair of telephone wires from the branch interface 106 to the first extension A, and connect the second and the third extensions B &C, to the first extension A in series. That is, the length of the telephone wire required for connecting the exchange 10 to the three extensions A-C is about 300 meters, and only one branch interface 106 is occupied. However, in the case of other types of conventional exchanges, total 600 meters of telephone wire and total three branch interfaces 106 are required to connect the three extensions A-C to the exchange. Therefore, with the time-division multiplexing exchange system of the present invention, total 300 meters of telephone wire and two branch interfaces are saved, compared to the conventional exchange system.

The extensions 20 are preferably digital telephones having a structure shown in FIG. 3. Each of the extensions 20 has a second microprocessor 202, a second customized IC 204, a second transceiving circuit 206, and a second transformer 208. Wherein, the second microprocessor 202, the second customized IC 204, the second transceiving circuit 206, and the second transformer 208 are structurally similar to the first microprocessor 102 and the first customized IC 104 in Ithe exchange 10, and the first transceiving circuit and the first transformer in each branch interface 106, except that the second microprocessor 202 controls the communication functions and flows of the extension 20 via programs, and the second customized IC 204 functions to connect the second microprocessor 202 to the second transceiving circuit 206. The second microprocessor 202, the second customized IC 204, the second transceiving circuit 206, and the second transformer 208 may be otherwise provided in a box, which is then externally connected to and between a general phone set and a general phone cord.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A time-division multiplexing (TDM) exchange system consisting of at least one exchange, said at least one exchange comprising:
a first microprocessor functioning to provide time-division multiplex communication services to a plurality of communication terminal devices;
a first customized integrated circuit (IC); and
a plurality of branch interfaces connected to said first microprocessor via said first customized integrated circuit; and each of said branch interfaces including a first transceiving circuit and a first transformer, and being connected to at least one communication terminal device via said first transformer and a pair of communication wires.

2. The TDM exchange system as claimed in claim 1, wherein each of said branch interfaces is connected to said at least one communication terminal device in parallel.

3. The TDM exchange system as claimed in claim 1, wherein each of said branch interfaces is connected to said at least one communication terminal device in series.

4. The TDM exchange system as claimed in any one of claims 1 to 3, wherein said communication terminal device includes a second microprocessor, a second customized IC, a second transceiving circuit, and a second transformer.

5. The TDM exchange system as claimed in any one of claims 1 to 3, wherein said first transceiving circuit consists of a transistor adapted to conduct analog and digital signal conversion; and wherein said first transformer functions to couple signals and isolate direct current (DC) voltage.

6. The TDM exchange system as claimed in any one of claims 1 to 3, wherein said first microprocessor controls all functions and flows of said exchange via programs.

7. The TDM exchange system as claimed in claim 4, wherein said second microprocessor functions to control communication functions and flows of said communication terminal device via programs, said second customized IC connects said second microprocessor to said second transceiving circuit, said second transceiving circuit consists of a transistor adapted to conduct analog and digital signal conversion, and said second transformer functions to couple signals and isolate DC voltage.

8. The TDM exchange system as claimed in claim 1, wherein said communication terminal device is a digital telephone set.
